(19) United States
(12) Patent Application Publication
(10) Pub. No.: US 2012/0078654 A1
(43) Pub. Date: Mar. 29, 2012

(54) COMPUTERIZED METHOD TO ALERT AND REMIND PATIENTS OR CLIENTS OF THEIR APPOINTMENTS

(76) Inventor: Joseph M. DeGruttola, New Castle, PA (US)

(21) Appl. No.: 13/312,030

(22) Filed: Dec. 6, 2011

(51) Int. Cl. G06Q 50/22; H04W 4/12

(52) U.S. Cl. 705/2

(57) ABSTRACT

Method for providing doctor's offices and their patients a communication link at strategic times prior to their doctor's appointment to avoid unintentionally no-shows or missed appointments. It allows the doctor's office to do so without extra labor or equipment.

### CROSS REFERENCE TO RELATED APPLICATIONS

This non-provisional application claims priority from U.S. Provisional Patent Application Ser. No. 61/432,105, entitled HIGHLY NON-INTRUSIVE, PRIVATE SECURE METHOD TO ALERT AND REMIND PATIENTS OF THEIR DOCTOR'S APPOINTMENTS filed on Jan. 12, 2011, which is incorporated herein by reference.

### FIELD OF THE INVENTION

The present invention is related generally to the method steps of alerting, reminding, confirming, and rescheduling appointments, and in particular to an automated or semi-automated process of confirming patient appointments to reduce or eliminate no-shows.

### BACKGROUND OF THE INVENTION

Doctor's offices for years have been spending thousands of dollars to reduce “Failure to show” (FTS) or “No show” appointments with their patients. FTS causes the entire office to run ineffectively and consequently lose money.

Currently, doctor's office personnel, sometimes several of them, have to set appointment and hope the patient shows up, or call the patient personally to confirm the appointment, or pay for expensive equipment and extra phone lines to have a computer generate a call to the patients. All current methods require personnel and are proven ineffective to reduce or eliminate no-shows.

### SUMMARY OF THE INVENTION

The present invention are computerized method steps to give doctor's offices and their patients a communication link at strategic, predetermined times prior to their doctor's appointment. It allows the doctor's office to do so without extra labor or equipment. The present invention allows doctor's offices a more improved method (at least 60 to 70% more efficient) to contact their patients. It is a way to decrease “No Shows” or “Failure to Shows.” In today's world, mobile phones are owned by over 90% of Americans. Tomorrow's world will grow even closer toward 100% of Americans owning mobile phones. The present invention anticipates the increased reliance of smart phones by patients to help doctor's offices non-intrusively contact patients at a much greater rate through the patients' smart phone, which most keep with them everywhere they go and at all times. American's keep their mobile phones next to their bed, with them while they dress, with them going to visit friends, business trips, at their office, in their purse or car, during church, while they are at a wedding reception, and some are even using their mobile phones as their primary phone at their residents choosing not to have land lines.

The present invention (also referred to herein as TextMD) needs a user computer with a CD reader to upload operating software from the TextMD CD-rom that contains the programs to link the patients' mobile phone information to the TextMD computer/host platform so the confirming of appointments can be accomplished via text alerts. Alternatively, the operating software can be downloaded from the TextMD web site to the user's computer after the user has registered and is an authorized user.

One embodiment of the present invention includes CD start-up and updates that can arrive at the user's office (for example, a doctor's office) via USPS (mail) or delivery service (UPS or FedEx). The doctor's staff will install the CD-ROM into the office computer and upload the TextMD software of the present invention onto their existing computer containing their current scheduling software. The TextMD CD-ROM is programmed to start or launch automatically when the CD-ROM is inserted into the CD drive of the office computer. The TextMD CD-ROM will contain pre-programmed code linking the doctor's office with the present invention (TextMD) SMS/MMS platform system. This stage can take ten (10) to fifteen (15) minutes for the computer system to finish uploading depending on the user's computer system capabilities.

After the upload of TextMD operating software is complete and the patients' permission slip is approved and filed, the doctor's office scheduler will set the appointments as usual while now entering the additional information relating to the patient's mobile phone thus initiating the alerts and reminders of the present invention.

The patient's mobile phone will receive a text alert from the present invention (TextMD) platform SMS/MMS system confirming their appointment without involving the office staff and without using any phone lines from the doctor's office. The present invention automatically sends an alert via text message to the patient's mobile phone. The message reads with the patient's name and reads that the named doctor's office is confirming their appointment with the actual date and time. It sends the reminder, for example, 48 or 24 hours prior to appointment to confirm the date and time. A final reminder can be sent the morning of the appointment as a backup. The text alert transmission times are chosen and approved by the patient in the permission slip.

This present invention will include safe guards that comply with Health Insurance Portability and Accountability Act (HIPAA) of 1996 (P.L.104-191), which are more confidential than any other patient appointment scheduling system available today. The present invention is also a non-intrusive system.

The patient receiving the text alert can confirm the appointment by replying “C” and pushing ENTER on their mobile phone. The present invention alerts the doctor's office scheduling computer automatically when the patient transmits the confirmation. When the doctor's office staff prints out their appointments for the day (prior to starting and/or prior to finishing the day), the staff will see that the patient confirmed via text alert.

The present invention allows doctor's offices an option to give their patients another option to receive a text alert confirming their appointment in a highly secure, non-intrusive, accurate way. The present invention works with the goal and premise that the office staff can increase efficiency by eliminating the task of making patient reminder phone calls or other communications, and without bottlenecking doctor's office computers or phone lines. The present invention prevents an awkward and disliked job that a staff member has to do each day calling patients. It increases the moral in the workplace while decreasing the no show appointments, thereby increasing efficiency in the workplace.

If the patient does not give permission to use their mobile phone to confirm their appointment with the present invention, then doctor's office must use other systems or methods.

The present invention is applicable to any field or industry, which plans or sets appointments for business to person or business-to-business.

### BRIEF DESCRIPTION OF THE DRAWINGS

For the present invention to be easily understood and readily practiced, the invention will now be described, for the purposes of illustration and not limitation, in conjunction with the following figure, wherein:

FIG. 1 is a schematic of the network of the present invention;

FIGS. 2A and 2B are flow diagrams of the present invention;

FIG. 3 is an exemplary example of a permission slip used by a doctor's office to obtain permission to contact the patient via text messages;

FIG. 4 is an illustration of an exemplary doctor's office calendar linked with the present invention or a calendar of the present invention;

FIG. 5 is an illustration of a pop-up screen of the present invention to input patient or client information for use with the alert text of the present invention;

FIG. 6 is an illustration of an alternative pop-up screen of the present invention to input patient or client information for use with the alert text of the present invention;

FIG. 7 is an illustration of an alert text of the present invention based on the pop-up screen information of FIG. 4 shown on a patient's or client's cell phone or smart phone;

FIG. 8 is an illustration of an alternative alert text of the present invention based on the pop-up screen information of FIG. 5 shown on a patient's or client's cell phone or smart phone;

FIG. 9 is an illustration of a report to the doctor of the patient's or client's appointment status; and

FIG. 10 is an illustration of an alert text of the present invention of a doctor's cancellation of the patient's or client's appointment.

### DETAILED DESCRIPTION OF THE INVENTION

The present invention will be illustrated with examples of web page screen shots and forms, and it is not intended to limit the present invention to disclosed embodiments.

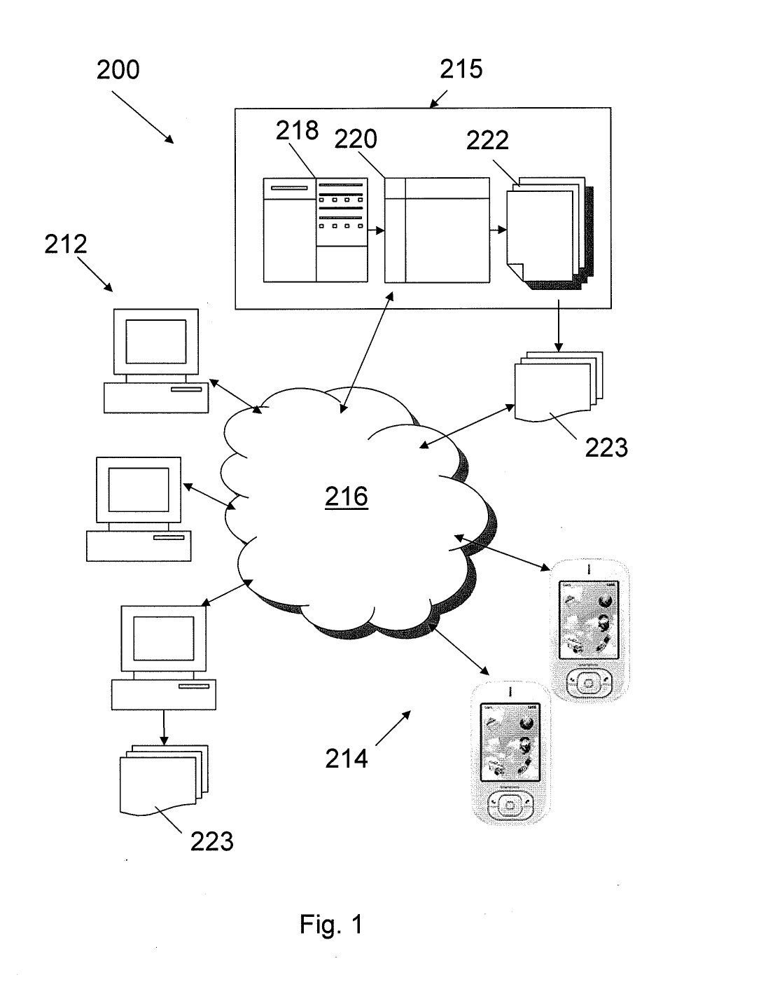

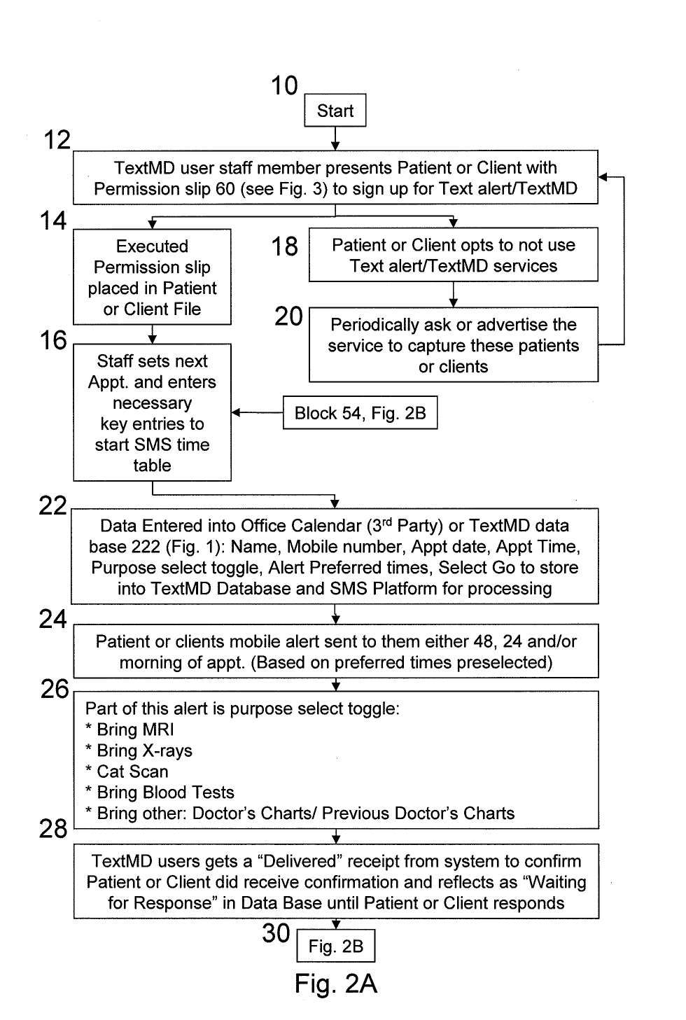

Now turning to FIG. 1 illustrating a schematic of one embodiment of the network 200 of the present invention (referred to herein also as TextMD). Network 200 includes TextMD users 212 (for example, doctors or attorneys) and patients or clients 214 that link or communicate with internet, web-based platform (web site) 215 via the internet 216. Internet, web-based platform (web site) 215 includes web host server 218 in communication with storage device 220 that contains data base 222 of system files and logic. Reports 223 can be generated by web site 215 and by TextMD users 212 for patient or client appointment status discussed in detail below.

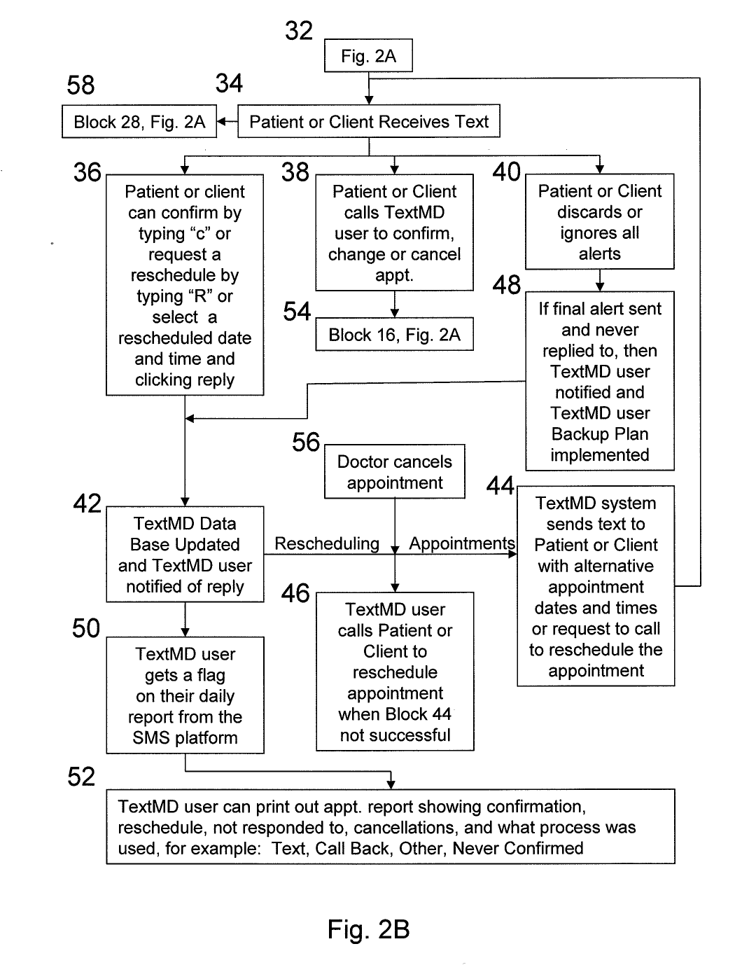

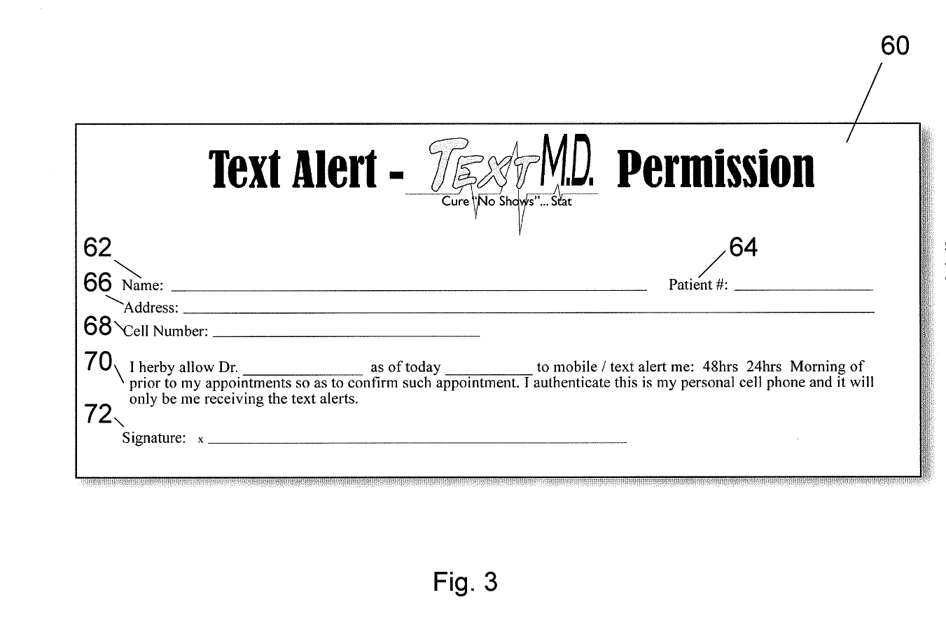

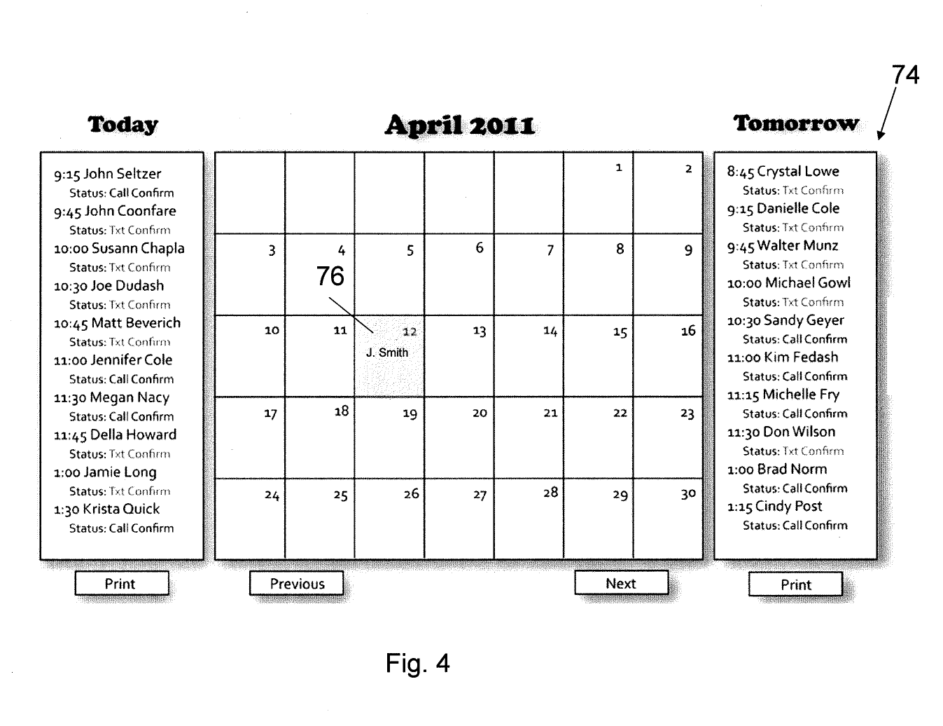

FIGS. 2A and 2B illustrate the primary elements (such as steps, decisions, etc.) of the present invention. Block 10 illustrates the start of the present invention with Block 12 illustrating a TextMD user staff member presenting a patient or client with a permission slip 60 (see FIG. 3) to sign up for Text alert from the TextMD network 200 (see FIG. 1). While patients are signing in for a doctor's visit or updating their insurance forms, the office staff will explain the TextMD alert system to contact them prior to future appointments. It will be the patient's choice to use this method. Doctor's office will ask current and new patients to fill-out, for example, a 2-ply permission slip. The permission slip with the patient's original signature will go into the patient's folder (Block 14) and a copy of the permission slip will be given to the patient. Block 16 illustrates that the doctor's office staff can set up the next appointment by opening a third party scheduling software with an office calendar page or the TextMD calendar 74 page (see FIG. 4) via an the Internet connection 216 (see FIG. 1).

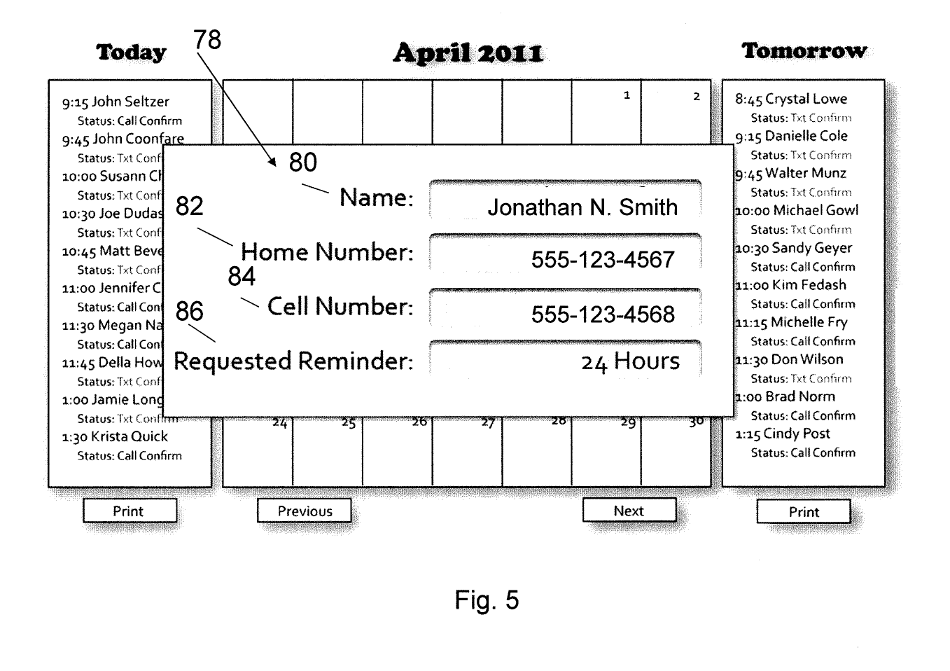

Now turning to FIGS. 4 and 5, once the date 76 has been selected, for example April 12, for patient Jonathan N. Smith, then the calendar page 74 will open a pop-up screen 78 to prompt necessary key entries to start the short message service (SMS), such as name 80, home number 82, cell phone 84, and requested reminder 86.

Now turning to FIG. 2A, Block 22 illustrates that entered data is stored in TextMD data base 222 (see FIG. 1) and SMS platform for processing. Block 18 illustrates that a patient or client can opt out of the text alert system, and Block 20 illustrates that the doctor's office can periodically ask the patient or client in the future if they would opt in to the service.

Now turning to FIG. 3, permission slip 60 will include all legal notices required under HIPAA and can include information such as name 62, patient number 64, address 66, cell phone number 68, permission statement 70, and patient signature 72.

Now returning to FIG. 2A, Block 24 illustrates the automated transmission of the text alert message to the patient's or client's cell phone informing of the next appointment. There can be multiple alerts sent at any given time interval including 48 hours, 24 hours, and/or morning of the appointment. The present invention can include pre-selected times or the user can input a custom time interval.

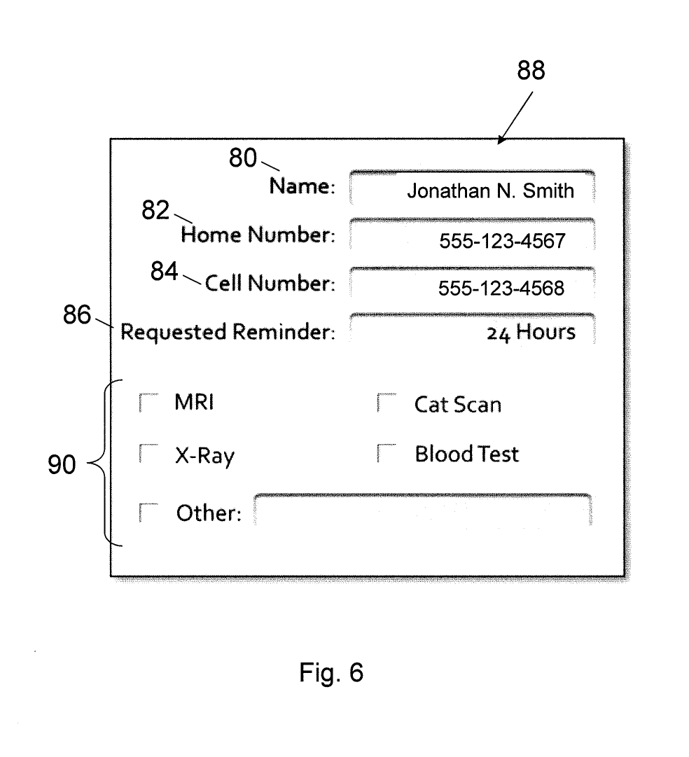

Block 26 illustrates another embodiment of the present invention that provides the option to include in the text message items for the patient or client to bring with him/her to the appointment, such as x-rays, blood tests, or another or previous doctor's charts. Now turning to FIG. 6 illustrating an alternative calendar page that will open a pop-up screen 88 to prompt necessary key entries to start the short message service (SMS), such as name 80, home number 82, cell phone 84, requested reminder 86, and items to bring to the appointment 90, such as MRI, X-ray, Cat Scan, Blood Test, and other.

Block 28 illustrates that once the text alert message is sent to the patient or client (Block 24) and received by patient or client (Block 34 of FIG. 2B), then the TextMD users 212 (see FIG. 1) receive a “delivered” receipt from the present invention (Block 58 of FIG. 2B) to confirm that the patient or client did receive confirmation and the TextMD data base reflects that the system is “Waiting for Response” (Block 28 of FIG. 2A) until the patient or client responds, discussed in detail below.

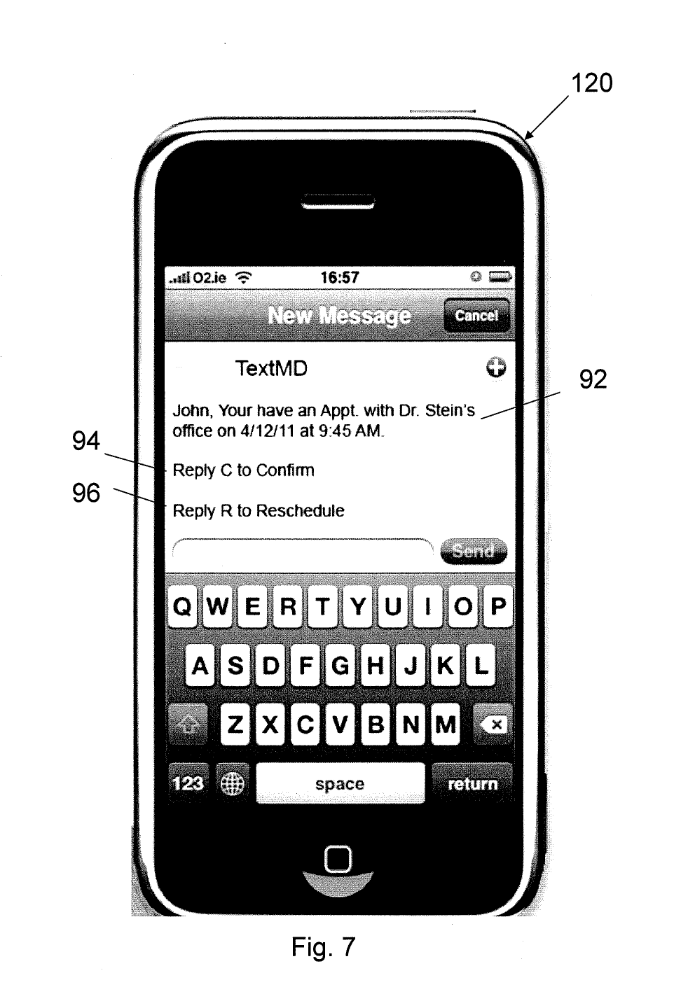

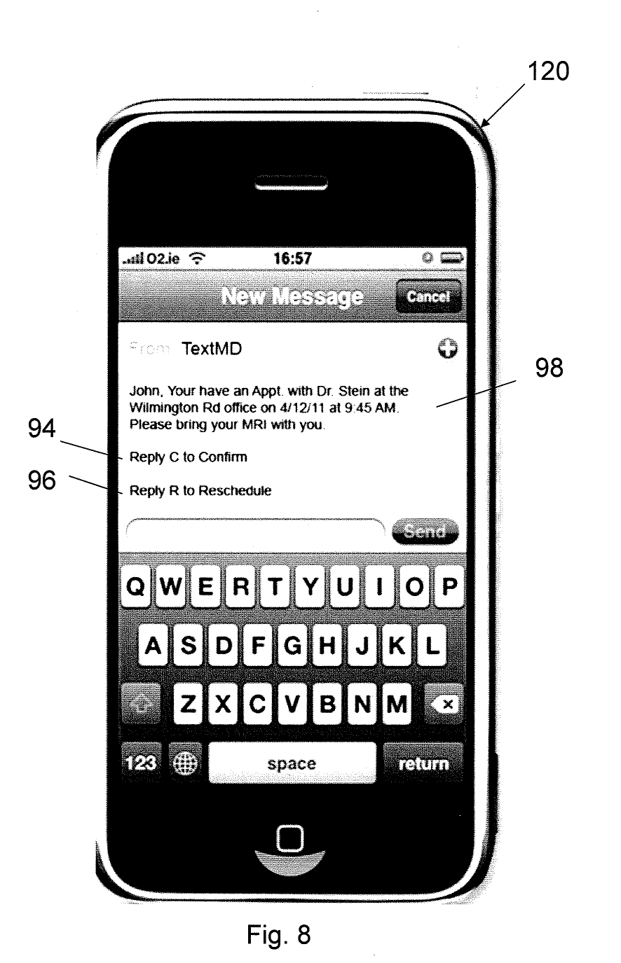

Now turning to FIG. 2B, the patient or client has many options upon receipt of the alert text message 92 (see FIG. 7), 98 (see FIG. 8). The patient or client can ignore the alert (Block 40) and not respond to the alert. The present invention will continue to send alerts until a final alert is sent and not responded to (Block 48). At this stage, the TextMD user 212 (see FIG. 1) will need to implement alternative backup procedures to ascertain whether the patient or client will be keeping the appointment. The patient or client can call the TextMD user or doctor's office to confirm, change, or cancel the appointment (Block 38). Block 54 illustrates that the present invention will loop back to Block 16 of FIG. 2A to set up another appointment and the process will continue from there.

Now turning to FIG. 7, the patient or client can use her/her cell phone 120 to reply to the received text alert 92, for example send “C” 94 to confirm, “R” 96 to reschedule, or select a reschedule date (not shown) when “R” had been sent in a previous reply. Block 36 of FIG. 2B illustrates the step of the process of the patient's or client's reply.

Now turning to FIG. 8 that illustrates the received text alert 98 of the alternative embodiment 88 (see FIG. 6) with instructions to bring items (e.g. MRI) to the appointment. As discussed above for FIG. 7, the patient or client can use her/her cell phone 120 to reply to the received text alert 92, for example send “C” 94 to confirm, “R” 96 to reschedule, or select a reschedule date (not shown) when “R” had been sent in a previous reply. Block 36 of FIG. 2B illustrates the step of the process of the patient's or client's reply.

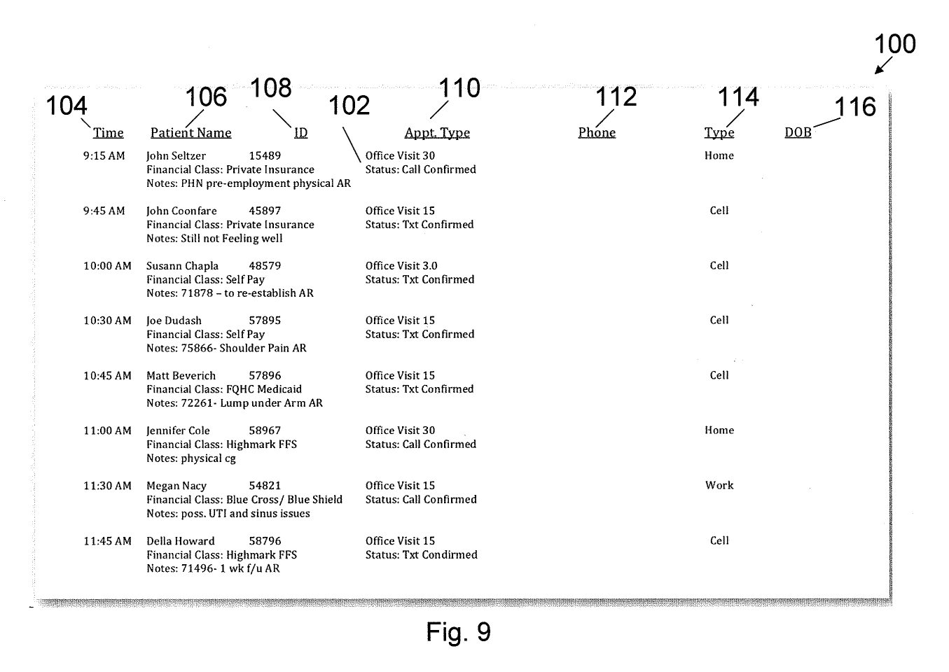

Now returning to FIG. 2B, Block 42 illustrates that the patient or customer reply will be sent to the TextMD data base 222 (see FIG. 1) to update the patient client record and the TextMD user 212 (see FIG. 1) will be notified of the reply. Blocks 50 and 52 illustrate that the TextMD users 212 can receive reports (see FIG. 9), for example daily reports, to view how many texts were sent, delivered, not delivered, confirms, reschedules, and opt-outs. The present invention can color code each entry, such as confirmations are red, for easy visual recognition by the doctor's office staff. FIG. 9 illustrates a TextMD report 100 to the TextMD user 212 showing the latest status 102 of the patient's or client's appointment. The report 100 also can contain other pertinent information fields such as, but not limited to, appointment time 104, patient's name 106, patient's identification number 108, appointment type 110, patient's telephone number 112, type of phone 114, and date of birth 116.

In the case of requesting to reschedule the appointment (Block 36 of FIG. 2B), TextMD rescheduling software will intelligently go into the doctor's third party or TextMD calendar 74 (see FIG. 4) and search for closest available appointment parameters, such as time of day and days of week. The doctor's office calendar controls many of the parameters and the TextMD system 200 cross references parameters and matches the doctor's office parameters with the patient preference profile, such as routine days off, work schedule, planned vacation or personal days). After the matching process is completed by the TextMD system 200, a text message 92 (see FIG. 7), 98 (see FIG. 8) is sent to the patient or client with a list of alternative dates and times. The patient or client can select one of the alternative dates and times and send the reply back to the TextMD system 200 for coordination with the doctor's office as explained above. Alternatively, the patient or client selects the option that none of the dates and times are acceptable and requesting a staff member from the doctor's office to call the patient or client to schedule the appointment (Block 46 of FIG. 2B). Once the new appointment date is input to the calendar system 74, the text alerts will be initiated again for reminders to be sent out to the patient or client.

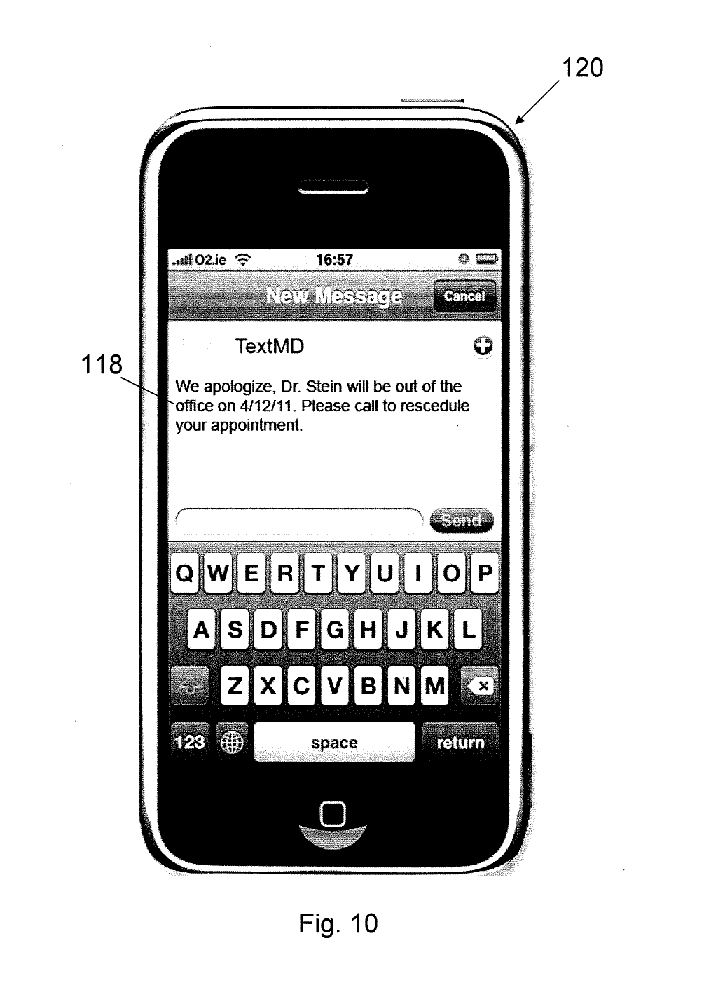

In the case of the doctor canceling the appointment (Block 56 of FIG. 2B), TextMD provides the doctor's and patients with a few options. One option is for the doctor to request that the patient to call the doctor to reschedule the appointment (see 118 of FIG. 10, Block 44 of FIG. 2B). Another option is for the doctor's office to call the patient or client to schedule the new appointment (Block 46, FIG. 2B). The other option is the same as the TextMD system rescheduling software discussed above.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

What is claimed is:

1. An electronic appointment reminder process comprising steps of:
providing a web site operated by a web site host, wherein the web site comprises a server and a data base;
registering a user on the web site server via an internet connection;
creating a client file associated with the user on the web site data base;
transmitting by the user of client information to the web site server for storage in the client file, wherein the client information comprises (i) a client's name, (ii) a client's cell phone number; (iii) a next appointment date and time; (iv) an alert reminder transmission time, and (v) a status of the transmitted alert reminder;
storing the client information in the client file on the web site data base;
building an alert reminder by the web site server based on the client information;
transmitting the alert reminder by the web site server to the cell phone of the client when the alert reminder transmission time occurs;
updating the status of the transmitted alert reminder in the web site data base that the alert reminder was transmitted to the cell phone of the client;
updating the status of the transmitted alert reminder in the web site data base in response to a delivery receipt confirmation from the cell phone of the client;
transmitting the delivery receipt confirmation of the alert reminder to the user by the web site server; and
monitoring by the web site server for a reply by the cell phone of the client in response to the alert reminder.

2. The process according to claim 1, further comprising steps of:
transmitting a reply by the user to the web site server in response to the alert reminder;
receiving by the web site server of the reply;
updating the status of the transmitted alert reminder in the web site data base in response to the reply; and
transmitting the reply by the web site server to the user.

3. The process according to claim 1, wherein the alert reminder as a short message service (SMS) text.

4. The process according to claim 1, further comprising a step of transmitting the status of the reply after a predetermined period of time by the web server to the user.

5. The process according to claim 1, wherein the status of the transmitted alert reminder comprises awaiting reply, confirmed, and reschedule.

6. The process according to claim 1, wherein the step of building the alert reminder by the web site server based on the client information comprises a list of user reply options.

7. The process according to claim 6, wherein the list of user reply options comprises “C” for confirm and “R” for reschedule.

8. The process according to claim 1, wherein the client information further comprises a list of items the client should bring to the appointment.

9. The process according to claim 8, wherein the list of items comprises a Cat Scan, an X-ray, a previous doctor's report, a blood test, and an editable text field.

10. The process according to claim 1, further comprising steps of:
storing in the client information on the data base another alert reminder transmission time;
building another alert reminder by the web site server based on the another alert reminder transmission time;
transmitting the another alert reminder by the web site server to the cell phone of the client when the another alert reminder transmission time occurs;
updating the status of the transmitted another alert reminder in the web site data base that the another alert reminder was transmitted to the cell phone of the client;
updating the status of the transmitted another alert reminder in the web site data base in response to another delivery receipt confirmation from the cell phone of the client;
transmitting the another delivery receipt confirmation to the user by the web site server; and
monitoring by the web site server for the reply by the client in response to the another alert reminder.

11. The process according to claim 1, further comprising a step of creating a report of client appointment status.

12. The process according to claim 11, wherein the step of creating a report of client appointment status is performed by the user.

13. The process according to claim 11, wherein the step of creating a report of client appointment status is performed by the web site server and transmitted to the user over the internet connection.

14. The process according to claim 11, wherein the report of each client appointment status selected from the group consisting of: appointment confirmation, appointment to be rescheduled, alert reminders not responded to, and appointment cancelled.

15. The process according to claim 7, further comprising steps of:
evaluating alternative appointment dates and times when the reply is reschedule;
transmitting by the user the alternative appointment dates and times to the web site server to update the client information, wherein (iii) the next appointment date is updated with the alternative appointment dates and times; and (iv) the alert reminder transmission time is reset to a predetermined time;
storing the updated client information in the client file on the web site data base;
building an updated alert reminder by the web site server based on the updated client information;
transmitting the updated alert reminder by the web site server to the cell phone of the client when the updated alert reminder transmission time occurs;
updating the status of the transmitted updated alert reminder in the web site data base that the updated alert reminder was transmitted to the cell phone of the client;
updating the status of the transmitted updated alert reminder in the web site data base in response to a delivery receipt confirmation from the cell phone of the client;
transmitting the delivery receipt confirmation of the updated alert reminder to the user by the web site server; and
monitoring by the web site server for an updated reply by the cell phone of the client in response to the updated alert reminder.

16. The process according to claim 1, further comprising steps of:
cancelling the appointment by the user;
evaluating alternative appointment dates and times;
transmitting by the user the alternative appointment dates and times to the web site server to update the client information, wherein (iii) the next appointment date is updated with the alternative appointment dates and times; and (iv) the alert reminder transmission time is reset to a predetermined time;
storing the updated client information in the client file on the web site data base;
building an updated alert reminder by the web site server based on the updated client information;
transmitting the updated alert reminder by the web site server to the cell phone of the client when the updated alert reminder transmission time occurs;
updating the status of the transmitted updated alert reminder in the web site data base that the updated alert reminder was transmitted to the cell phone of the client;
updating the status of the transmitted updated alert reminder in the web site data base in response to a delivery receipt confirmation from the cell phone of the client;
transmitting the delivery receipt confirmation of the updated alert reminder to the user by the web site server; and
monitoring by the web site server for an updated reply by the cell phone of the client in response to the updated alert reminder.
